(19) United States
(12) Patent Application Publication
(10) Pub. No.: US 2017/0314716 A1
(43) Pub. Date: Nov. 2, 2017

(54) LAY-FLAT HIGH PRESSURE HOSE AND METHOD OF MANUFACTURING SAME

(71) Applicant: Anthony G. Warren, Edmonton (CA)

(72) Inventor: Anthony G. Warren, Edmonton (CA)

(21) Appl. No.: 15/499,741

(22) Filed: Apr. 27, 2017

Related U.S. Application Data
(60) Provisional application No. 62/329,583, filed on Apr. 29, 2016.

(51) Int. Cl. F16L 33/213; F16L 33/18; F16L 33/01; F16L 33/34; F16L 11/08

(52) U.S. Cl. CPC F16L 33/213; F16L 33/34; F16L 11/085; F16L 33/01; F16L 33/18

(57) ABSTRACT

A high-pressure lay-flat hose and fitting that can be used at pressures in excess of 1000 psig, and its method of manufacture, is provided.

### CROSS-REFERENCE TO RELATED APPLICATIONS

This application claims priority of U.S. provisional patent application Ser. No. 62/329,583 filed Apr. 29, 2016, which is incorporated by reference into this application in its entirety.

### TECHNICAL FIELD

The present disclosure is related to the field of lay-flat hoses, in particular, lay-flat hoses that withstand pressures in excess of 1000 psig.

### BACKGROUND

Lay-flat conduit capable of withstanding burst pressures in excess of 1000 psig with an internal diameter greater than 2.5 inches is a relatively new field.

It is, therefore, desirable to provide a device/apparatus/system/method/process that overcomes the shortcomings of the prior art.

### SUMMARY

Successful implementation of this type of conduit is achieved with the use of relatively high diameter fibre bundles woven or braided to provide the tensile attributes necessary to achieve the structural requirements for withstanding high pressure. Operating under high pressure, the conduit liner may conform to the texture of the fibre structure, resulting in a liner that is not smooth enough to maintain a reliable seal at the fitting connection.

In some embodiments, a device can be utilized that can be inserted on the outside of the innermost layer of the conduit in order to provide sufficient rigidity to allow the proper makeup of the seal to the liner as the fitting stem can be expanded internally against the conduit and the ferrule of the fitting.

In some embodiments, a conduit of three independent layers can be used. This conduit can comprise: 1) an inner liner made of any number of elastomeric materials; 2) a reinforcing layer made of high tensile strength fibres or wires woven or braided to provide sufficient structural strength to withstand internal pressures contemplated in the conduit design; and 3) a protective outer layer designed to protect the fibre materials from external harm (environmental or physical).

In some embodiments, the inner layer or liner can be trimmed short from the end of the other layers of the conduit. The fitting stem, having a number of seals of sufficient hardness and flexibility, can be inserted into the inner diameter of the liner material. A smooth, relatively stiffer device that is at least 100% of the outer diameter of the liner can be inserted over the liner, concurrent with the area of the seals on the ferrule end of the fitting stem. In some embodiments, an adhesive can be further applied to the exposed fibrous material to saturate the material. The stem can then be expanded as per known art.

In some embodiments, this can result in the adhesion of the fibre layer directly to the stem of the fitting, which can aid in the retention of end forces against the fitting as the conduit is put into pressurized service. Placed between the liner and the fibre, the device made of smooth, relatively stiffer material can prevent the liner from conforming to the texture of the fibre layer. The ability of the conduit liner to retain a smooth surface relative to the reinforcing material can allow the liner and the seals to form intimate contact and to create a highly efficient seal between the fluid in the conduit and the external environment.

Broadly stated, in some embodiments, a hose fitting can be provided for a hose, the hose comprising an inner diameter extending substantially therethrough, and further comprising a portion thereof defining a hose end, the hose end comprising an inside diameter larger than the inner diameter, the hose fitting comprising: a tubular first end comprising one or more attachment grooves disposed circumferentially therearound and configured for attachment to a hose coupler, the first end comprising a first inner diameter; a tubular neck portion disposed adjacent to the first end, the neck portion narrowing in diameter from the first inner diameter to a second inner diameter, wherein the second inner diameter is less than the first inner diameter; a tubular stem portion disposed adjacent to the neck portion, wherein the neck portion is disposed between the first end and the stem portion, the stem portion comprising an internal diameter substantially equal to the second inner diameter; a ferrule comprising a tubular member configured to be fitted coaxially over the stem portion, wherein the hose end can be fitted annularly between the ferrule and the stem portion; and wherein the stem portion is further configured to expand in diameter when an installation plug is pulled therethrough to secure the hose fitting to the hose end.

Broadly stated, in some embodiments, a hose can be provided comprising an inner diameter extending substantially therethrough, and further comprising a portion thereof defining a hose end, the hose end comprising an inside diameter larger than the inner diameter, the hose comprising: a hose fitting disposed in the hose end, the hose fitting comprising: a tubular first end comprising one or more attachment grooves disposed circumferentially therearound and configured for attachment to a hose coupler, the first end comprising a first inner diameter, a tubular neck portion disposed adjacent to the first end, the neck portion narrowing in diameter from the first inner diameter to a second inner diameter, wherein the second inner diameter is less than the first inner diameter, a tubular stem portion disposed adjacent to the neck portion, wherein the neck portion is disposed between the first end and the stem portion, the stem portion comprising an internal diameter substantially equal to the second inner diameter, and a ferrule comprising a tubular member configured to be fitted coaxially over the stem portion, wherein the hose end can be fitted annularly between the ferrule and the stem portion; and wherein the stem portion is expanded in diameter when the hose end is fitted annularly between the ferrule and the stem portion to secure the hose fitting to the hose end.

Broadly stated, in some embodiments, the neck portion can further comprise a ring disposed circumferentially, at least partially, therearound, the ring configured to engage the ferrule when the stem portion is expanded in diameter.

Broadly stated, in some embodiments, the ferrule can comprise a ring groove therein configured to receive the ring when the stem portion is expanded in diameter.

Broadly stated, in some embodiments, the hose fitting can further comprise adhesive disposed at least partially annularly between the stem portion and the hose end.

Broadly stated, in some embodiments, the adhesive can comprise an epoxy adhesive.

Broadly stated, in some embodiments, the hose fitting can further comprise at least one seal member disposed between the stem portion and the hose end when the stem portion is expanded in diameter.

Broadly stated, in some embodiments, the at least one seal member can further comprise at least one seal groove disposed circumferentially around a distal end of the stem portion, and an o-ring disposed in at least one of the at least one seal groove.

Broadly stated, in some embodiments, the distal end can further comprises an outer diameter that is less than the inner diameter.

Broadly stated, in some embodiments, the hose fitting can further comprise a backing ring configured to be disposed between a hose liner and a fibre sleeve of the hose.

Broadly stated, in some embodiments, a method can be provided for attaching a hose fitting to a hose end thereof, the hose comprising an inner diameter extending substantially therethrough, the method comprising the steps of: removing a portion of an inner surface of the hose at the hose end to provide a relieved area thereon, wherein the hose end comprises an inside diameter larger than the inner diameter; providing the hose fitting, the hose fitting comprising: a tubular first end comprising one or more attachment grooves disposed circumferentially therearound and configured for attachment to a hose coupler, the first end comprising a first inner diameter, a tubular neck portion disposed adjacent to the first end, the neck portion narrowing in diameter from the first inner diameter to a second inner diameter, wherein the second inner diameter is less than the first inner diameter, a tubular stem portion disposed adjacent to the neck portion, wherein the neck portion is disposed between the first end and the stem portion, the stem portion comprising an internal diameter substantially equal to the second inner diameter, and a ferrule comprising a tubular member configured to be fitted coaxially over the stem portion, wherein the hose end can be fitted annularly between the ferrule and the stem portion; fitting the hose end annularly between the ferrule and the stem portion; and expanding the diameter of the stem portion to secure the hose fitting to the hose end.

Broadly stated, in some embodiments, the method can further comprise the step of providing a ring circumferentially, at least partially, around the neck portion and engaging the ferrule with the ring when the stem portion is expanded in diameter.

Broadly stated, in some embodiments, the method can further comprise the step of providing a ring groove in the ferrule configured to receive the ring when the stem portion is expanded in diameter.

Broadly stated, in some embodiments, the method can further comprise the step of applying adhesive at least partially annularly between the stem portion and the hose end.

Broadly stated, in some embodiments, the method can further comprise the step of providing at least one seal member between the stem portion and the hose end.

Broadly stated, in some embodiments, the method can further comprise the steps of providing at least one seal groove circumferentially around a distal end of the stem portion, and providing an o-ring in at least one of the at least one seal groove.

Broadly stated, in some embodiments, the method can further comprise the step of placing a backing ring between a hose liner and a fibre sleeve of the hose prior to fitting the hose end annularly between the ferrule and the stem portion.

### BRIEF DESCRIPTION OF THE DRAWINGS

FIG. 1 is a side elevation cross-section view depicting a first embodiment of a hose fitting for a high-pressure lay-flat hose.

FIG. 2 is a front perspective cross-section view depicting the hose fitting of FIG. 1.

FIG. 3 is a rear perspective cross-section view depicting the hose fitting of FIG. 1.

FIG. 4 is a side elevation cross-section view depicting a second embodiment of a hose fitting for a high-pressure lay-flat hose.

### DETAILED DESCRIPTION OF EMBODIMENTS

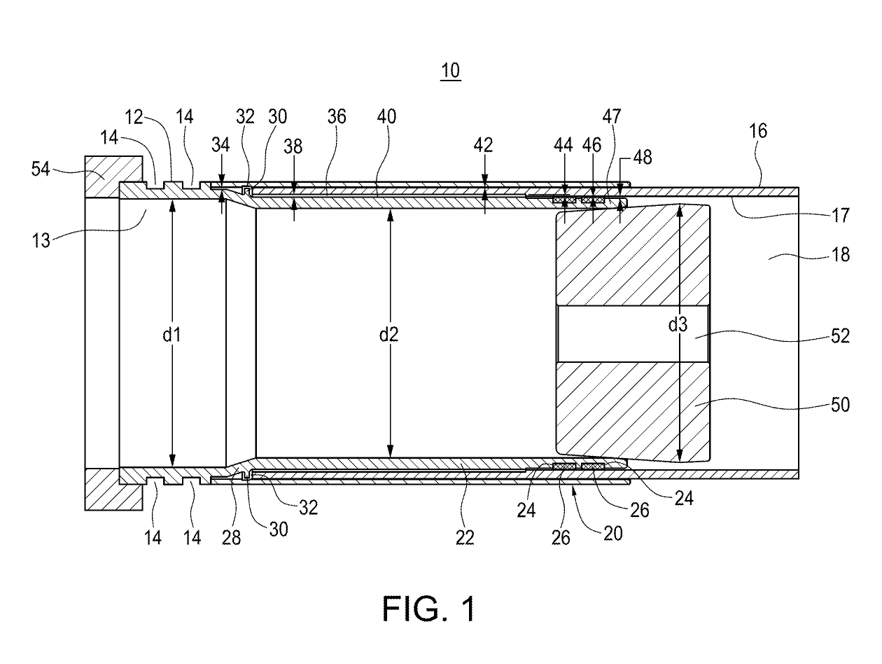

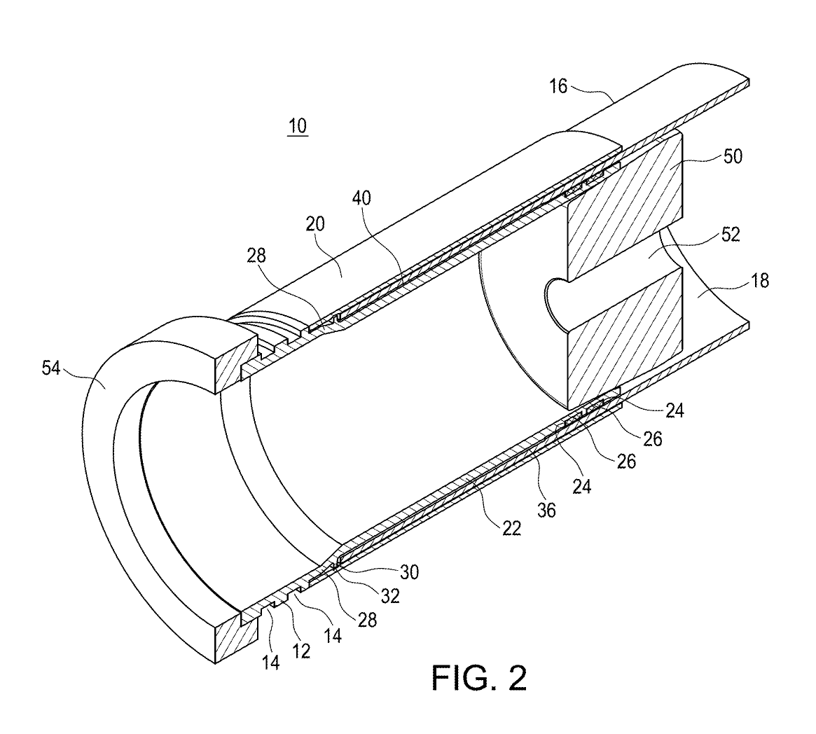

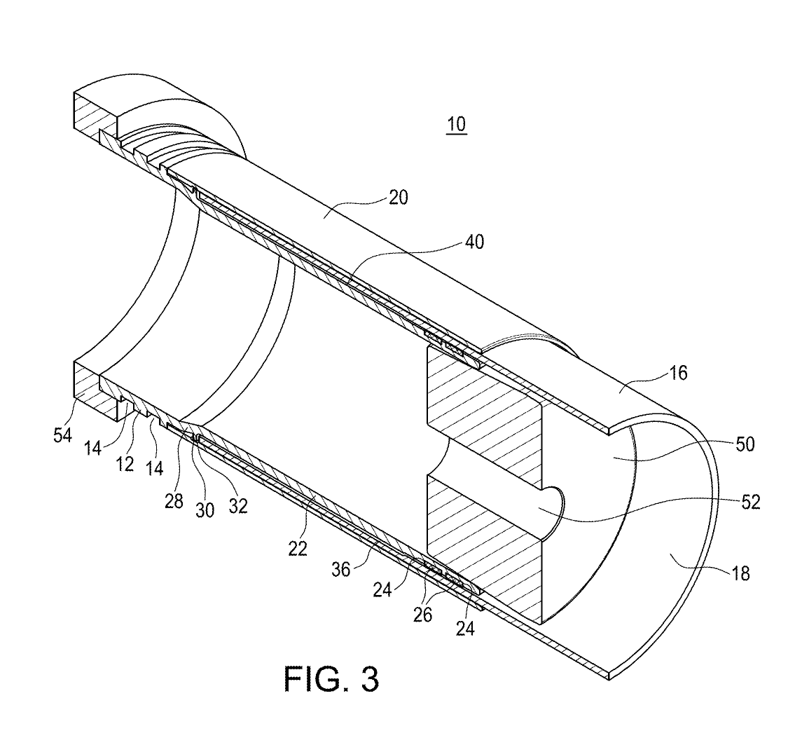

Referring to FIGS. 1 to 3, a first embodiment of high-pressure lay-flat hose connection 10 is shown. In some embodiments, hose connection 10 can comprise hose 16 operatively attached to hose fitting 12 with ferrule 20. In some embodiments, hose 16 can comprise a conduit extruded from a flexible liner material surrounded by a seamless fibre sleeve, as described and illustrated in Canadian Patent Application No. 2,433,914 filed on Jun. 27, 2003, which is incorporated into this application by reference in its entirety. Such a configuration can be able to withstand high pressure contents of up to 25,000 psig, braided or woven in a substantially continuous manner around the liner. The fibre sleeve can be overlaid on the liner but free therefrom and, in some embodiments, is not fused or fixably connected to the liner whereby, the sleeve absorbs the tensile forces in the conduit.

The material from which the conduit liner is extruded can be any flexible material according to the intended contents of the conduit which may include liquid, gas or slurries. The liner can be formed of ultra-high molecular weight polyethylene, polypropylene or polyolefin, but can also be formed of a linear low density polyethylene. Alternate embodiments can comprise virtually any kind of liner material from the traditional rubber or vinyl to ultra-high molecular weight polyethylene, polypropylenes, TPU or fluorinated polycarbons such as Kynar™. The material utilized to create the liner will affect the ultimate performance characteristics of the conduit.

The fibre sleeve can be fashioned from any high tensile strength yarn, including Kevlar™, Vectran™ or M5 but, in some embodiments, can comprise a gel-spun ultra-high molecular weight polyethylene. This can create a hose that is able to withstand high pressure contents of up to 25,000 psig and can also be flexible and easy to roll-up, so that the conduit can be stored and transported without difficulty.

The fibre sleeve can be woven or braided in a seamless and substantially continuous manner to create a conduit of any length. Any weave or braid technique can be applied to create a seamless sleeve.

In some embodiments, a coating and overweave can be adhered to the fibre sleeve to protect the conduit. In the circumstance that the fibre sleeve is created from a material that resists bonding of a coating thereto, a chemical process, according to U.S. Pat. No. 4,880,879 can be applied, which is incorporated into this application by reference in its entirety. Any coating, including PVC, vinyls, or rubber materials can be applied by way of any adhesive agent, if necessary, preferably the coating is dual component MDT or TDI cured polyurea or polyurethane bonded to the fibre sleeve by a polar adhesive. In some embodiments, the protective overweave can be created from any fibre including polyester, Vectran™ or nylon but can also be created from Kevlar™.

In some embodiments, fitting 12 can comprise neck portion 28 that narrows or tapers in diameter, from diameter d1 in mouth 13, to diameter d2 in stem portion 22. In some embodiments, the outer diameter of stem portion 22 can be selected to provide annular gap 48 between stem portion 22 and inside wall 17 of hose 16. In a representative embodiment, gap 48 can be 0.040″.

In some embodiments, a portion of inside wall 17 can be removed to provide relief area 36 resulting in annular gap 38 between stem portion 22 and hose 16. In a representative embodiment, annular gap 38 can be 0.060″.

In some embodiments, ferrule 20 can comprise an inside diameter such that it can provide annular gap 34 between ferrule 20 and neck portion 28, and can further provide an interference fit with hose 16. In a representative embodiment, annular gap 34 can be 0.038″, and annular gap 42 between ferrule 20 and hose 16 can be 0.002″.

In some embodiments, a method to attach fitting 12 to hose 16 can comprised pulling plug 50 through stem portion 22 from distal end 47 towards installation tool 54 placed on fitting 12. As well known to those skilled in the art, plug 50 can comprise a frustum or wedge shape having diameter d3, which is greater than diameter d2 but less than or equal to diameter d1. An installation rod or bolt (not shown) disposed in hole 52 can be used to pull plug 50 through stem portion 22 towards to mouth 13. Installation tool 54 can be used to stabilize fitting 12 as plug 50 is pulled towards mouth 13. In so doing, stem portion 22 can be expanded in diameter to compress hose 16 between stem portion 22 and ferrule 20 and, thus, attach fitting 12 to hose 16. Plug 50 and installation tool 54 can then be removed from fitting 12. In some embodiments, fitting 12 can be comprised of iron, an alloy thereof, or of any other material, as well known to those skilled in the art, that comprises malleable properties that enable it to expand in diameter, and to substantially retain the expanded diameter, when plug 50 is pulled therethrough.

In some embodiments, neck portion 28 can further comprise ring 30 extending radially away, at least partially, circumferentially therefrom. Ferrule 20 can further comprise groove 32 configured to receive ring 30 when plug 50 is pulled through stem portion 22 to attach fitting 12 to hose 16.

In some embodiments, adhesive 40 can be placed, at least partially, around stem portion 22 to further adhere hose 16 to stem portion 22 when plug 50 is pulled through stem portion 22 to attach fitting 12 to hose 16. In yet further embodiments, adhesive 40 can comprise an epoxy adhesive. In other embodiments, adhesive 40 can comprise any other adhesive suitable for adhering hose 16 to stem portion 22, as well known to those skilled in the art having regard to specific materials hose 16 and stem potion 22 are comprised of, which can include polyvinyl acetate (“PVA”) adhesive as one example.

In some embodiments, distal end 47 of stem portion 2 can comprise one or more seal grooves 24 disposed circumferentially therearound for receiving o-ring seals 26 to provide a seal between stem portion 22 and inside wall 17 of hose 16 when plug 50 is pulled through stem portion 22 to attach fitting 12 to hose 16.

In some embodiments, fitting 12 can further comprise grooves 14 disposed circumferentially therearound for attachment to hose couplers, as well known to those skilled in the art.

In some embodiments, fittings 12 can be attached to both ends of a length of hose 16, which can be of any diameter of hose as typically used by those skilled in the art, for use to connect two pieces of equipment requiring a hose connection therebetween. In other embodiments, fitting 12 can be attached at one end of a length of hose 16 wherein the other end of hose 16 is attached or affixed to a piece of equipment.

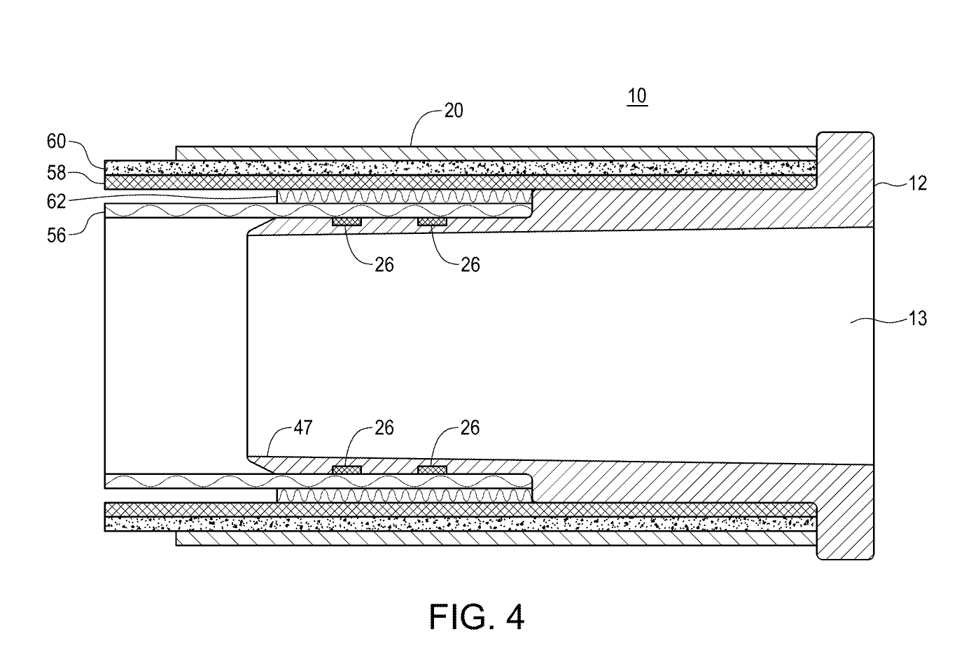

Referring to FIG. 4, a second embodiment of hose connection 10 is shown. As noted above, when referring to the first embodiment of hose connection 10, hose 16 can be comprised of a flexible liner material surrounded by a seamless fibre sleeve, wherein the flexible liner is given reference numeral 56, the fibre sleeve given reference numeral 58. In respect of the second embodiment of hose connection 10, in some embodiments, backing ring 62 can be disposed between hose liner 56 and fibre sleeve 58. In some embodiments, backing ring 62 can comprise a thin-wall tubular or sleeve configuration, and can be formed of ultra-high molecular weight polyethylene, polypropylene or polyolefin, but can also be formed of a linear low density polyethylene. Alternate embodiments of backing ring 62 can comprise virtually any kind of liner material from the traditional rubber or vinyl to ultra-high molecular weight polyethylene, polypropylenes, TPU or fluorinated polycarbons such as Kynar™. When plug 50 is pulled through fitting 12 to complete hose connection 10, backing ring 62 can provide additional means to secure the connection of hose liner 56 to fitting 12. Fitting 12 can further comprise seals 26 disposed around distal end 47 to further enable a seal between fitting 12 and hose liner 56.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

1. A hose fitting for a hose, the hose comprising an inner diameter extending substantially therethrough, and further comprising a portion thereof defining a hose end, the hose end comprising an inside diameter larger than the inner diameter, the hose fitting comprising:
a) a tubular first end comprising one or more attachment grooves disposed circumferentially therearound and configured for attachment to a hose coupler, the first end comprising a first inner diameter;
b) a tubular neck portion disposed adjacent to the first end, the neck portion narrowing in diameter from the first inner diameter to a second inner diameter, wherein the second inner diameter is less than the first inner diameter;
c) a tubular stem portion disposed adjacent to the neck portion, wherein the neck portion is disposed between the first end and the stem portion, the stem portion comprising an internal diameter substantially equal to the second inner diameter;
d) a ferrule comprising a tubular member configured to be fitted coaxially over the stem portion, wherein the hose end can be fitted annularly between the ferrule and the stem portion; and
e) wherein the stem portion is further configured to expand in diameter when an installation plug is pulled therethrough to secure the hose fitting to the hose end.

2. The hose fitting as set forth in claim 1, wherein the neck portion further comprises a ring disposed circumferentially, at least partially, therearound, the ring configured to engage the ferrule when the stem portion is expanded in diameter.

3. The hose fitting as set forth in claim 2, wherein the ferrule comprises a ring groove therein configured to receive the ring when the stem portion is expanded in diameter.

4. The hose fitting as set forth in claim 1, further comprising adhesive disposed at least partially annularly between the stem portion and the hose end.

5. The hose fitting as set forth in claim 4, wherein the adhesive comprises an epoxy adhesive.

6. The hose fitting as set forth in claim 1, further comprising at least one seal member disposed between the stem portion and the hose end when the stem portion is expanded in diameter.

7. The hose fitting as set forth in claim 6, wherein the at least one seal member comprises at least one seal groove disposed circumferentially around a distal end of the stem portion, and an o-ring disposed in at least one of the at least one seal groove.

8. The hose fitting as set forth in claim 7, wherein the distal end comprises an outer diameter that is less than the inner diameter.

9. The hose fitting as set forth in claim 7, further comprising a backing ring configured to be disposed between a hose liner and a fibre sleeve of the hose.

10. A hose comprising an inner diameter extending substantially therethrough, and further comprising a portion thereof defining a hose end, the hose end comprising an inside diameter larger than the inner diameter, the hose comprising:
a) a hose fitting disposed in the hose end, the hose fitting comprising:
i) a tubular first end comprising one or more attachment grooves disposed circumferentially therearound and configured for attachment to a hose coupler, the first end comprising a first inner diameter,
ii) a tubular neck portion disposed adjacent to the first end, the neck portion narrowing in diameter from the first inner diameter to a second inner diameter, wherein the second inner diameter is less than the first inner diameter,
iii) a tubular stem portion disposed adjacent to the neck portion, wherein the neck portion is disposed between the first end and the stem portion, the stem portion comprising an internal diameter substantially equal to the second inner diameter, and
iv) a ferrule comprising a tubular member configured to be fitted coaxially over the stem portion, wherein the hose end can be fitted annularly between the ferrule and the stem portion; and
b) wherein the stem portion is expanded in diameter when the hose end is fitted annularly between the ferrule and the stem portion to secure the hose fitting to the hose end.

11. The hose as set forth in claim 10, wherein the neck portion further comprises a ring disposed circumferentially, at least partially, therearound, the ring configured to engage the ferrule when the stem portion is expanded in diameter.

12. The hose as set forth in claim 11, wherein the ferrule comprises a ring groove therein configured to receive the ring when the stem portion is expanded in diameter.

13. The hose as set forth in claim 10, further comprising adhesive disposed at least partially annularly between the stem portion and the hose end.

14. The hose as set forth in claim 13, wherein the adhesive comprises an epoxy adhesive.

15. The hose as set forth in claim 10, further comprising at least one seal member disposed between the stem portion and the hose end when the stem portion is expanded in diameter.

16. The hose as set forth in claim 15, wherein the at least one seal member comprises at least one seal groove disposed circumferentially around a distal end of the stem portion, and an o-ring disposed in at least one of the at least one seal groove.

17. The hose as set forth in claim 16, wherein the distal end comprises an outer diameter that is less than the inner diameter.

18. The hose as set forth in claim 10, wherein the hose fitting further comprises a backing ring configured to be disposed between a hose liner and a fibre sleeve of the hose.

19. A method for attaching a hose fitting to a hose end thereof, the hose comprising an inner diameter extending substantially therethrough, the method comprising the steps of:
a) removing a portion of an inner surface of the hose at the hose end to provide a relieved area thereon, wherein the hose end comprises an inside diameter larger than the inner diameter;
b) providing the hose fitting, the hose fitting comprising:
i) a tubular first end comprising one or more attachment grooves disposed circumferentially therearound and configured for attachment to a hose coupler, the first end comprising a first inner diameter,
ii) a tubular neck portion disposed adjacent to the first end, the neck portion narrowing in diameter from the first inner diameter to a second inner diameter, wherein the second inner diameter is less than the first inner diameter,
iii) a tubular stem portion disposed adjacent to the neck portion, wherein the neck portion is disposed between the first end and the stem portion, the stem portion comprising an internal diameter substantially equal to the second inner diameter, and
iv) a ferrule comprising a tubular member configured to be fitted coaxially over the stem portion, wherein the hose end can be fitted annularly between the ferrule and the stem portion;
c) fitting the hose end annularly between the ferrule and the stem portion; and
d) expanding the diameter of the stem portion to secure the hose fitting to the hose end.

20. The method as set forth in claim 19, further comprising the step of providing a ring circumferentially, at least partially, around the neck portion and engaging the ferrule with the ring when the stem portion is expanded in diameter.

21. The method as set forth in claim 20, further comprising the step of providing a ring groove in the ferrule configured to receive the ring when the stem portion is expanded in diameter.

22. The method as set forth in claim 19, further comprising the step of applying adhesive at least partially annularly between the stem portion and the hose end.

23. The method as set forth in claim 22, wherein the adhesive comprises an epoxy adhesive.

24. The method as set forth in claim 19, further comprising the step of providing at least one seal member between the stem portion and the hose end.

25. The method as set forth in claim 24, further comprising the step of providing at least one seal groove circumferentially around a distal end of the stem portion, and providing an o-ring in at least one of the at least one seal groove.

26. The method as set forth in claim 25, wherein the distal end comprises an outer diameter that is less than the inner diameter.

27. The method as set forth in claim 19, further comprising the step of placing a backing ring between a hose liner and a fibre sleeve of the hose prior to fitting the hose end annularly between the ferrule and the stem portion.
